(19) United States
(12) Patent Application Publication
(10) Pub. No.: US 2024/0384678 A1
(43) Pub. Date: Nov. 21, 2024

(54) TURBULENT JET IGNITION INTERNAL COMBUSTION ENGINE WITH PRE-CHAMBER HAVING A DUCT FOR EXHAUST GAS RECIRCULATION

(71) Applicant: FERRARI S.P.A., Modena (MO) (IT)

(72) Inventor: Fabio Santi MORTELLARO, Modena (MO) (IT)

(21) Appl. No.: 18/665,223

(22) Filed: May 15, 2024

(30) Foreign Application Priority Data
May 18, 2023 (IT) 102023000010023

(51) Int. Cl. F02B 19/10; F02B 19/12

(52) U.S. Cl. CPC F02B 19/1004; F02B 19/12

(57) ABSTRACT

An internal combustion engine for a motor vehicle is disclosed that includes a cylinder, a cylinder head, a piston that can slide inside the cylinder, a first chamber defined between the cylinder, the cylinder head, and the piston, a second chamber distinct from the first chamber and communicating with the first chamber via one or more ports, fuel inlet means configured to introduce a fuel mixture into at least one between the first and second chambers, and an ignition device arranged at the second chamber and configured to ignite the fuel mixture in the second chamber, characterized by comprising a vent line configured to vent gas from the second chamber, the vent line having an inlet end arranged at the second chamber.

### CROSS-REFERENCE TO RELATED APPLICATION

This patent application claims priority from Italian patent application no. 102023000010023, filed on May 18, 2023, the entire disclosure of which is incorporated herein by reference.

### TECHNICAL FIELD

The invention relates to an internal combustion engine, in particular a turbulent jet ignition internal combustion engine.

### BACKGROUND

Turbulent jet ignition for internal combustion engines is a known technology, in particular with past applications in the race car field and naval field.

According to this technology, in addition to the typical combustion chambers delimited by the cylinders, pistons, and cylinder head, the turbulent jet ignition internal combustion engine also has a pre-chamber connected to each of the combustion chambers.

The pre-chamber or secondary chamber is formed on a volume separate from that defined by the corresponding combustion chamber or main chamber, but communicates with the latter via multiple ports.

The engine has a fuel introduction device in the main chamber, for example a fuel injector, as well as a pipe for introducing air into the same main chamber, since the latter may contain a fuel mixture formed from the air and introduced fuel.

The mixture is pushed into the pre-chamber through the ports during the engine's compression step.

Here, i.e. in the pre-chamber, the engine has an ignition device, for example a typical spark plug, to light the mixture, i.e. to trigger the combustion of the mixture.

The mixture combusted in the pre-chamber moves turbulently, passing through the ports, so as to be divided into multiple radial jets in the main chamber.

Therefore, the combustion continues inside the main chamber with several flame fronts meeting from the peripheral zones towards the centre of the main chamber, rather than with a single flame front starting from the ignition point towards the peripheral zones, as occurs, instead, in common spark-ignition engines.

This can lead to achieving higher compression ratios, without any knocking phenomena.

On the other hand, turbulent jet ignition may have critical aspects associated with the ignition capacity of the mixture in the pre-chamber.

In particular, the factors that favour optimal ignition of the mixture in the pre-chamber are the turbulence of the mixture at the ignition device and the absence of combustion residues, such as unburnt hydrocarbons, carbon dioxide, and nitrogen oxides.

Clearly, the construction of the pre-chamber and of the ports inevitably entails an accumulation of combustion residues that do not pass into the main chamber through the ports, thus ceasing to flow near the ignition device.

In addition, for some engine operating conditions, for example with low revs and low operating loads, the turbulence of the mixture decreases.

Therefore, these operating conditions may be critical and, potentially, trigger the failed ignition of the mixture, so that the engine idles.

Therefore, the turbulent jet ignition engine is well suited for applications in which the minimum level of revs is relatively high, as in the case of race cars, or in which the level of revs tends to be constant, as in the case of ships.

On the other hand, there is a need to improve the applicability of the turbulent jet ignition engine for road vehicles, in particular Gran Turismo ones.

Known improvement attempts involve, for example, introducing air, fuel, or another mixture directly into the pre-chamber before ignition. In these cases, the pre-chamber is called active rather than passive as per the basic application described above.

However, these attempts are not yet fully satisfying due to the following drawbacks, as well as the necessary and obvious complication of the engine due to the addition of devices suitable for directly feeding the pre-chamber.

A first drawback associated with the cases in which additional air is fed to the pre-chamber is linked to the pressure with which the air must be introduced into the pre-chamber.

In fact, the mixture entering the pre-chamber is already pressurised since pushed into the pre-chamber during the engine compression step. Therefore, the additional added air must have a pressure greater than that of the mixture, which entails a significant additional complexity linked to the need to provide relatively power and bulky compression devices to compress the additional air.

Therefore, in these cases, the additional air is fed in advance of ignition, i.e. when the pressure in the pre-chamber is not excessively high. Therefore, this latter measure reduces the turbulence of the mixture, so it is not fully effective.

The first drawback can be overcome in those cases where only the fuel is fed into the pre-chamber via a special injector. In fact, the injector enables high-pressure fuel injection, so that the fuel can be basically injected at the time of the injection thus ensuring the mixture's high turbulence.

On the other hand, the injection of just fuel into the pre-chamber has other drawbacks. In particular, a second drawback is linked to the fact that the addition of fuel produces a rich mixture in the pre-chamber with the resulting increase in combustion residues stagnating in the pre-chamber.

A third drawback exists when the ignition phasing is delayed. In this case, part of the additional, injected fuel risks being re-sucked into the main chamber with a net deterioration in the quality of the combustion.

Thus, there is also a need to overcome or at least attenuate the drawbacks noted above.

One purpose of the invention is to satisfy at least one of the needs mentioned, preferably in a simple and reliable way.

### DESCRIPTION OF THE INVENTION

In one aspect, the invention can be an internal combustion engine for a motor vehicle, the internal combustion engine comprising a cylinder, a cylinder head arranged to cover the cylinder, a piston slidingly coupled to the cylinder inside the cylinder between a lower dead centre and an upper dead centre respectively further and closer than the cylinder head, a first chamber defined between the cylinder, the cylinder head, and the piston, a second chamber distinct from the first chamber and communicating with the first chamber via one or more ports formed on at least one component between the cylinder head and the cylinder, fuel inlet means configured to introduce a fuel mixture into at least one between the first and second chambers, an ignition device arranged at the second chamber and configured to ignite the fuel mixture in the second chamber, and a vent line configured to vent gas from the second chamber, the vent line having an inlet end arranged at the second chamber.

In one aspect, the invention can be an internal combustion engine for a motor vehicle, the internal combustion engine comprising a cylinder, a cylinder head covering the cylinder, a piston slideable inside the cylinder between a lower dead centre and an upper dead centre, the upper dead centre being closer to the cylinder head than the lower dead centre, a first chamber defined between the cylinder, the cylinder head, and the piston, a second chamber distinct from the first chamber and communicating with the first chamber via one or more ports formed on at least one of the cylinder head and the cylinder, a fuel inlet configured to introduce a fuel mixture into at least one of the first chamber and the second chamber, an ignition device arranged at the second chamber and configured to ignite the fuel mixture in the second chamber, and a vent line configured to vent gas from the second chamber, the vent line having an inlet end arranged at the second chamber.

### BRIEF DESCRIPTION OF THE DRAWINGS

Below, embodiments of the invention are described to better understand the same by way of non-limiting examples and with reference to the attached drawings in which:

FIG. 1 is a diagram of a portion of a motor vehicle comprising an internal combustion engine according to one embodiment of the invention;

FIG. 2 is a portion of a longitudinal cross-section of the internal combustion engine;

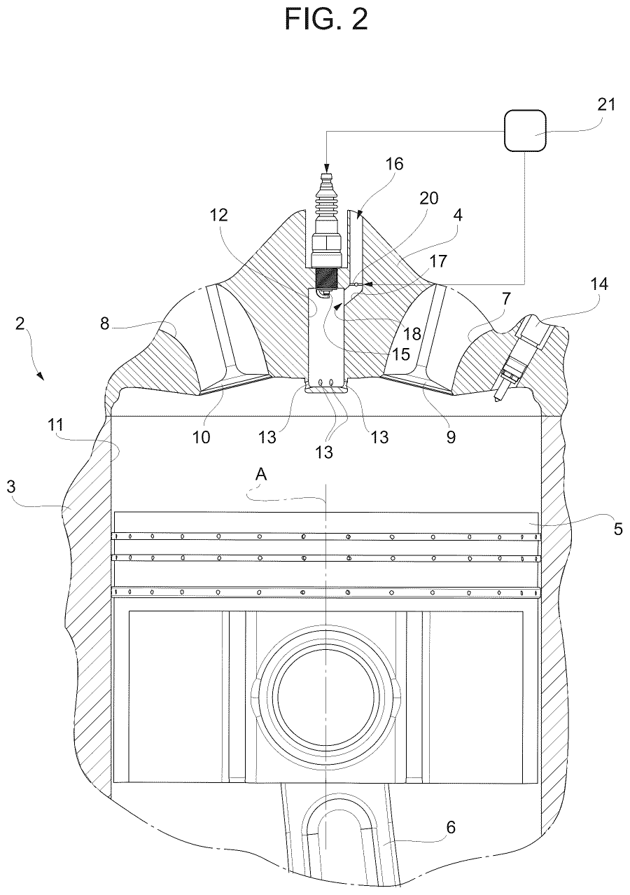

FIG. 3 is a perspective view of a pre-chamber of the internal combustion engine; and

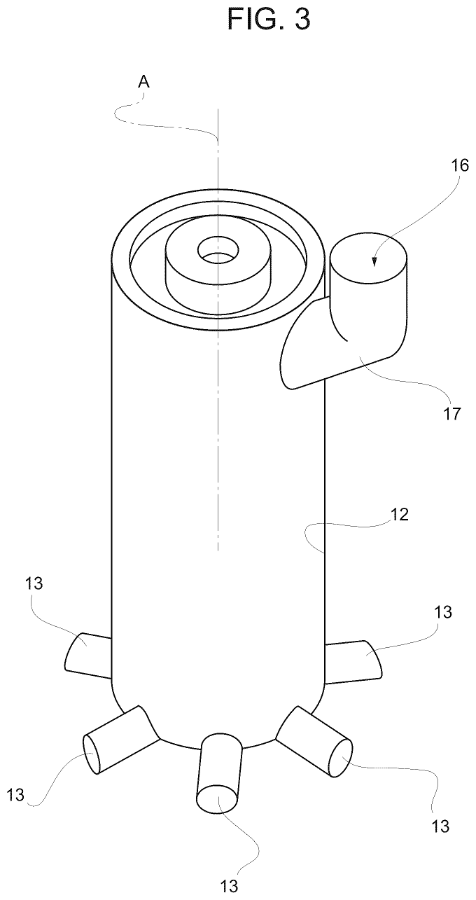

FIG. 4 is a graph representing the trend of an operating parameter of an air-fuel mixture during a combustion cycle of the internal combustion engine.

### DETAILED DESCRIPTION OF THE INVENTION

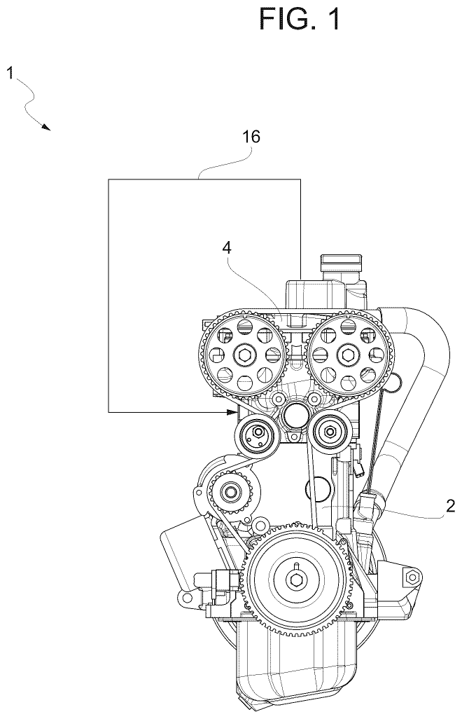

In FIG. 1, the reference number 1 is used to indicate, as a whole, a motor vehicle.

The motor vehicle 1 comprises an internal combustion engine 2. The engine 2 is a volumetric engine, in particular an alternating one.

The engine 2 comprises at least one cylinder 3 and a cylinder head 4 arranged to cover the cylinder 3. In practice, the cylinder head 4 closes the cylinder 3.

The engine 2 could comprise multiple cylinders, for example arranged in a line or according to a V configuration, without any loss of generality.

In the use context of the motor vehicle 1, the cylinder head 4 is arranged higher than the cylinder 3, so that it closes or covers the cylinder 3 from above.

The engine 2 comprises a piston 5 slidingly coupled to the cylinder 3 inside the cylinder 3 between a lower dead centre and an upper dead centre, which define the ends of the stroke of the piston 3.

The lower dead centre and the upper dead centre are, respectively, further from and closer to the cylinder head 4.

More precisely, the cylinder 3 has a straight axis A, along which the stroke of the piston 5 extends. In other words, the piston 5 is mobile along the axis A between the lower dead centre and the upper dead centre.

The engine 2 has as known engine shaft that is not illustrated, as well as a piston rod 6 (partially illustrated) that couples the piston 5 to the engine shaft according to known methods.

In addition, the coupling between the piston 5 and the cylinder 3 is known and is not, therefore, described in greater detail.

The engine 2 is preferably a four-stroke engine, although this is not, in any case, essential.

The operation of the engine 2 has at least one compression step, in which the piston 5 returns from the lower dead centre to the upper dead centre.

The engine 2 comprises an intake manifold and an exhaust manifold that are not illustrated.

In addition, the engine 2 comprises an intake pipe 7 configured to connect the intake manifold inside the cylinder 3.

Similarly, the engine 2 comprise an exhaust pipe 8 configured to connect the inside of the cylinder 3 to the exhaust pipe.

In particular, the intake pipe 7 and the exhaust pipe 8 are formed on the cylinder head 4.

The intake manifold and the exhaust manifold are not strictly necessary; in general, the function of the intake pipe 7 and the exhaust pipe 8 is to allow, respectively, the introduction of air into the cylinder 3 and the expulsion of exhaust gas from the cylinder 3.

The engine 2 has an intake valve 9 and an exhaust valve 10 respectively coupled to the intake pipe 7 and to the exhaust pipe 8 to selectively enable or interrupt the communication between the cylinder 3 and the intake and exhaust manifolds or, more generally, with the outside of the engine 2.

The operation of the intake valve 9 and the exhaust valve 10 is controlled by a cam shaft that is not illustrated, which is rotated by the engine shaft using the so-called distribution in a known way not described in further detail.

The engine 2 is a turbulent jet ignition engine, so it comprises a first chamber or combustion chamber 11 defined between the cylinder 3, the cylinder head 4, and the piston 5, as well as a second chamber or pre-chamber 12 separated from the first chamber 11 and communicating via one or more ports 13.

In detail, the ports 13 are formed on the cylinder head 4, although they could also, alternatively or in addition, be formed on the cylinder 3, according to embodiments not illustrated. In other words, the ports 13 are formed on at least one component defined by the cylinder head 4 or by the cylinder 3, or on both the cylinder 3 and the cylinder head 4.

In addition, irrespectively, the pre-chamber 12 is preferably formed on the cylinder head 4, although not necessarily.

The ports 13 extend, in particular, along respective transversal axes or, more precisely, those having a radial component in relation to the axis A.

The ports 13 or, in particular, the corresponding axes are oriented towards the lateral, inner surface of the cylinder 3 and/or towards the piston 5.

The engine 2 comprises a fuel introduction assembly configured to introduce a fuel mixture in at least one of the following: the combustion chamber 11 and the pre-chamber 12, considering that the latter communicate between them via the ports 13.

More specifically, the fuel mixture comprises air and a fuel, for example petrol.

The fuel introduction assembly comprises, in particular, the intake pipe 7 and the corresponding intake valve 9 as far as regards the introduction of air.

In particular, the intake pipe 7 has an intake opening directly communicating with the combustion chamber 11.

Selectively, the intake valve 9 is configured to completely block or at least partially free the intake opening, thus respectively preventing and enabling the introduction of air into the combustion chamber 11.

Similarly, though independently, the exhaust pipe 8 has an exhaust opening directly communicating with the combustion chamber 11.

Selectively, the exhaust valve 10 is configured to completely block or at least partially free the exhaust opening, thus respectively preventing and enabling the expulsion of exhaust gases from the combustion chamber 11.

In addition, the fuel introduction assembly comprises a fuel introduction device 14, for example an injector, in particular a known one.

The fuel introduction device 14 is configured to introduce fuel into the combustion chamber 11, in particular directly, for example via injection.

Therefore, the mixture initially forms inside the combustion chamber 11.

The fuel introduction assembly can potentially also include the piston 5, since the latter is configured to push the mixture into the pre-chamber 12 through the ports 13 in the compression step of the engine 2, when the piston 5 moves from the lower dead centre to the upper dead centre or, more generally, towards the upper dead centre.

Therefore, the piston 5 is configured to introduce the mixture (initially formed in the combustion chamber 11) in the pre-chamber 12.

The engine 2 also comprises an ignition device 15, for example a spark plug, arranged in the pre-chamber 12.

The ignition device 15 is configured to ignite the mixture in the pre-chamber 12. In other words, the ignition device 15 is configured to trigger the combustion of the mixture inside the pre-chamber 12.

According to the invention, the engine 2 comprises a vent line 16 configured to vent gas from the pre-chamber 12. The vent line 16 has an inlet end 17 arranged at the pre-chamber 12.

More specifically, the inlet end 17 ends with an inlet opening 18 directly facing the pre-chamber 12 or directly communicating with the pre-chamber 12.

The vent line 16 is preferably configured to recirculate the vented gases from the pre-chamber 12 into the combustion chamber 11.

In particular, the vent line 16 recirculates the vented gases in the intake manifold or in the intake pipe 7, so that the vented gases re-enter the combustion chamber 11 through the intake pipe 7, more specifically during an intake step of the engine 2, i.e. when the piston 5 descends from the upper dead centre towards the lower dead centre after the exhaust gases have been expelled through the exhaust pipe 8.

The vent line 16 is preferably defined by a pipe, in particular a single one, which places the pre-chamber 12 in communication (in particular, direct communication) with the intake pipe 7 or, more preferably, the intake manifold (upstream of the intake pipe 7), without additional branches, in particular direct from the vent line 16 towards intermediate accumulation volumes or tanks between the pre-chamber 12 and the intake manifold, to avoid a potential reflux of exhaust gases towards the pre-chamber 12. The pipe preferably extends along the axis A, without annular portions around the axis A.

The escape of the vented gases from the pre-chamber 12 corresponds to washing the pre-chamber 12 of such gases.

In other words, the vent line 16 defines a pipe EGR, i.e. a recirculation pipe for the exhaust gases leaving the pre-chamber 12 through the inlet end 17 or the inlet opening 18.

In particular, the vent line 16 is configured to recirculate the totality or 100% of the gases leaving the pre-chamber 12 through the inlet end 17 or the inlet opening 18 in the combustion chamber 11.

The vent line 16 preferably comprises a valve device 20 configured to control the flow of gas through the inlet end 17.

The valve device 20 is coupled to the inlet end 17.

The valve device 20 has at least one closed configuration, wherein it completely obstructs or blocks the inlet end 17, so that the flow of gas from the pre-chamber 12 through the inlet end 17 is prevented.

In other words, the closed configuration of the valve device 20 prevents the flow of gas from the pre-chamber 12 going beyond the inlet end 17.

Thus, the closed configuration of the valve device 20 prevents the evacuation of gases from the pre-chamber 12 via the vent line 16.

The valve device 20 has at least one open configuration, wherein the valve device 20 can be traversed by the flow of gas coming from the pre-chamber 12.

In other words, the open configuration of the valve device 20 allows the flow of gas from the pre-chamber 12 to go beyond the inlet end 17.

Thus, the open configuration of the valve device 20 allows the evacuation of gas from the pre-chamber 12 via the vent line 16.

Optionally, the valve device 20 in the open configuration can be controlled to reduce the flow of gas through the inlet end 17, i.e. to partially block the inlet end 17.

Alternatively, the valve device 20 could also be an on-off valve, so that there is only the closed configuration and the open configuration, in which it respectively completely blocks and frees the inlet end 17.

In terms of construction, the valve device 20 could comprise any type of known valve suitable for the functions described above, such as a throttle valve, a spool valve, a slide valve, or a ball valve, etc.

The engine 2 or the motor vehicle 1 comprises a control unit 21 configured to control the valve device 20, as well as the ignition device 15.

The control unit 21 controls the valve device 20 and the ignition device 15 as a function of a parameter indicating a position or movement of the piston 5, in particular in relation to a complete thermodynamic cycle of the engine 2.

As known, a four-stroke engine like the engine 2 in the specific, non-limiting embodiment illustrated requires that the piston 5 complete its whole stroke twice for every thermodynamic cycle.

Thus, the expression “position of the piston” 5 here refers to the complete thermodynamic cycle of the engine 2 rather than the mere spatial arrangement of the piston 5 along its stroke.

In other words, during the same thermodynamic cycle, although the piston 5 crosses the same intermediate point four times located between the lower and upper dead centre, in particular with reference to the two ascents towards the upper dead centre and the two descents towards the lower dead centre, the piston 5 will have, at that intermediate point, four separate, though spatially coinciding, positions since referring to the two ascents and two descents respectively.

The parameter mentioned above takes into account this aspect, which holds in general, for example even if the engine 2 were a two-stroke engine.

For example, the parameter could be a rotation angle of the engine shaft or a rotation angle of the piston rod 6, for example of the foot of the piston rod 6. Alternatively, the parameter could be a time, for example assessed as a function of the angular speed of the engine shaft, i.e. the parameter could be a function of the time and angular speed or a time as a function of the angular speed.

In fact, considering the example of the angle of rotation of the engine shaft (i.e. it also holds true for the other examples considered), the values of the angle could, for example, be contained in a range between 0° and 720°, so as to be completely descriptive or indicative of the actual position of the piston 5 with reference to the complete thermodynamic cycle.

In particular, angles spaced apart by 180° or multiples of 180°, for example 90°, 270°, 450°, and 630° all correspond to the same intermediate point of the stroke of the piston 5, but each separately identifies whether the piston 5 is traversing one of the ascents or one of the descents, thus uniquely defining the position of the piston 5.

Thus, more specifically, the parameter uniquely defines the position of the piston 5.

The control unit 21 can determine the parameter in many ways, for example by acquiring one or more quantities indicating the parameter, or based on the control signals that the same control unit 21 emits to control the engine 2.

For example, the control unit 21 could acquire or estimate the angular speed of the engine shaft and calculate the parameter as a function of the angular speed of the engine shaft.

In particular, if the parameter were the angle of rotation of the engine shaft, the control unit 21 would calculate an integral of the angular speed of the engine shaft to obtain the parameter.

The control unit 21 is configured to drive the ignition device 15, i.e. to ignite the mixture in the pre-chamber 12, when the parameter indicates that the piston 5 is at the ignition point.

The ignition point can be fixed and predetermined or adjustable, for example as a function of operating conditions in the engine 2 or motor vehicle 1. The ignition point or its link with the parameter is stored or calculated by the control unit 21.

The control unit 21 is configured to drive or conduct the valve device 20 in the open configuration before the piston 5 has reached the ignition point, i.e. before the parameter indicates that the ignition point has been reached.

Preferably, but not necessarily, the valve device 20 is driven into the open configuration during the compression step of the engine 2.

Alternatively, the valve device 20 could also be driven into the open configuration during an expansion step of the engine 2, but in any case, before the ignition point is reached.

More precisely, when the valve device 20 is driven into the open configuration, the piston 5 is in an opening point.

The opening point or its link with the parameter may be pre-determined and/or stored by the control unit 21.

Thus, the control unit 21 drives the valve device 20 into the open configuration from when the parameter identifies that the piston 5 has passed the opening point, in particular during a movement of the piston 5 towards the ignition point; i.e. it preferably occurs but not necessarily during the compression step of the engine 2.

In addition, the latter movement of the piston 5 is also preferably directed towards the upper dead centre, since the valve device 20 is preferably driven into the open configuration during the compression step of the engine 2.

The opening point is preferably in the last three quarters of the stroke of the piston 5 towards the upper dead centre or, more specifically, in the last four ninths of the stroke of the piston 5 towards the upper dead centre.

In particular, the control unit 21 holds the valve device 20 in the open configuration until the parameter indicates that the piston is at the last point, i.e. a closing point, before having reached the ignition point or at the ignition point.

A distance between the closing point and the ignition point is preferably smaller than or equal to a quarter of the stroke of the piston 5, or, more preferably, smaller than or equal to a sixth of the stroke of the piston 5, or, even more preferably, smaller than or equal to a ninth of the stroke of the piston 5.

The closing point or its link with the parameter may be pre-determined and/or stored by the control unit 21.

In particular, from a spatial perspective, the piston 5 in the closing point is arranged between the upper dead center (for example including it) and the spatial placement corresponding to the opening point.

In practice, the control unit 21 can keep the valve device 20 in the open configuration during the movement of the piston 5 towards the upper dead centre, as well as potentially (but not necessarily) beyond reaching the upper dead centre, i.e. during the subsequent movement of the piston 5 towards the lower dead centre.

In fact, the ignition point could be reached during the subsequent movement (i.e. downwards movement) of the piston 5, after the piston 5 has reached the upper dead centre.

The control unit 21 is preferably configured to normally hold (i.e. in conditions other than those described above) the valve device 20 in the closed configuration, i.e. to drive the valve device 20 so as to block the flow of gas through the valve device 20 itself, thus completely blocking the inlet end 17.

The control unit 21 is specifically configured to drive or guide the valve device 20 into the closed configuration when the parameter indicates that the piston 5 is at the ignition point or that the piston 5 has exceeded the closing point.

In addition, specifically, the control unit 21 is configured to drive or guide the valve device 20 into the closed configuration when the parameter indicates that the piston 5 is arranged between the lower dead centre and the placement corresponding to the opening point. This can happen irrespective of the fact that the piston 5 is ascending towards the upper dead centre or descending towards the lower dead centre.

Below, an operation process of the engine 2 is described with reference to a complete thermodynamic cycle.

The process starts with an intake step, in which the piston 5 descends from the upper dead centre to the lower dead centre.

Here, the intake valve 9 is open, i.e. it at least partially frees the intake opening, thus enabling the introduction of air into the combustion chamber 11.

The exhaust valve 10 is closed, i.e. it completely blocks the exhaust opening, thus preventing the expulsion of gas from the combustion chamber 11. The valve device 20 is held in the closed configuration.

Thus, the combustion chamber 11 draws in air during the intake step.

Immediately after the intake step, the process continues with the compression step.

Here, the piston 5 ascends from the lower dead centre towards the upper dead centre. The intake valve 9 and the exhaust valve 10 are closed.

The control unit 21 drives the valve device 20 into the open configuration when the piston 5 overtakes the opening point, for example during the compression step.

The control unit 21 will then drive the valve device 20 into the closed configuration when the piston 5 overtakes or reaches the closing position, for example during the compression step or even beyond the latter step.

The fuel introduction device 14 introduces the fuel into the combustion chamber 11, thus forming the mixture with the air taken in during the intake step.

The introduction of fuel into the combustion chamber 11 can occur during the compression step or even during the intake step; preferably, the fuel is introduced before the piston 5 reaches the opening point.

In the compression step, the piston 5 pushes the mixture from the combustion chamber 11 into the pre-chamber via the ports 13.

According to a possible definition of the compression step, the latter could end when the piston 5 reaches the ignition point.

The ignition point is preferably reached before the upper dead centre, but could coincide with the upper dead centre or even be achieved during the subsequent descent of the piston 5 towards the lower dead centre.

From here, the process continues with the ignition and expansion step.

The valve device 20 is driven into the closing step before reaching the ignition point, or, at the most, when the ignition point is reached.

While the valve device 20 is in the open configuration, part of the combustion products of the mixture as well as part of the fresh mixture introduced are evacuated via the vent line 16.

In particular, the combustion products of the mixture and the part of the fresh mixture introduced are recirculated into the combustion chamber 11 at a successive intake step of the following thermodynamic cycle.

The evacuation via the vent line 16 and potentially the recirculation of the combustion products of the mixture, as well as part of the fresh mixture introduced, may be understood as part of a pre-chamber 12 washing step.

During the ignition and expansion step, the mixture is ignited in the pre-chamber 12 by the ignition device 15.

The intake valve 9 and the exhaust valve 10 are closed.

The valve device 20 is held in the closed configuration.

The combustion of the mixture is followed by its expansion; the mixture being expanded is sprayed from the pre-chamber 12 to the combustion chamber 11 via the ports 13.

The mixture continues, therefore, its expansion in the combustion chamber 11, thus pushing the piston 5 towards the lower dead centre.

At this point, the process continues with an exhaust step.

During the exhaust step, the piston 5 ascends from the lower dead centre to the upper dead centre.

The exhaust valve 10 is open so as to at least partially free the exhaust opening, thus enabling the expulsion of the exhaust gases produced by the combustion of the mixture from the combustion chamber 11.

The intake valve 9 is closed so as to prevent the introduction of air into the combustion chamber 11.

From the above, the advantages of the engine 2 according to the invention are clear.

In particular, the vent line 16 enables the evacuation of combustion resides from the pre-chamber 12. In addition, the evacuation entails a flow of gas starting from the pre-chamber 12.

This means an increase of the turbulence of the mixture inside the pre-chamber 12 with benefits for the ignition capacity of the mixture.

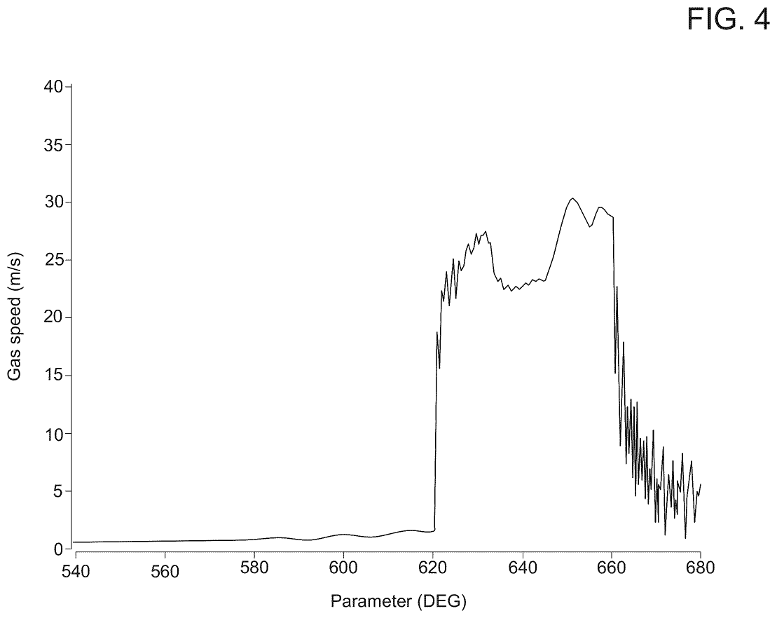

FIG. 4 is a graph that shows the trend of a speed of the gas (y axis) inside the pre-chamber 12 as a function of the already mentioned parameter (x axis).

FIG. 4 clearly clarifies the increase in the turbulence starting from the opening point (approximately 620°) up to the closing point (approximately 660°), in this example before the ignition point (approximately 680°).

The recirculation of gases evacuated from the pre-chamber 12 is advantageous since it prevents soiling substances from reaching the post-treatment devices of the exhaust system of the motor vehicle 1.

In relation to the solutions with active pre-chamber, the engine 2 is much simpler and provides performance that is not just comparable but, actually, better.

More specifically, in relation to the known solutions, the engine 2 is the only solution that enables the evacuation of the combustion residues of the preceding thermodynamic cycle.

In addition, in relation to the solution with injection of fuel into the pre-chamber, the mixture ignited in the pre-chamber is much thinner and closer to stoichiometric conditions.

Therefore, the combustion is more efficient and higher performing.

In addition, the ignition point may happily be delayed, without the risk of re-sucking the unburnt fuel into the combustion chamber 11 during the descent of the piston 5 towards the lower dead centre.

Finally, it is clear that changes may be made to the engine 2 according to the invention, and variations produced thereof, that, in any case, do not depart from the scope of protection defined by the claims.

In particular, the number and shape of the components described and illustrated could be different.

In addition, the engine 2 could have been a two-stroke engine, instead of a four-stroke one.

Finally, the fuel introduction device 14 could, for example, comprise an apparatus with carburetor, instead of an injector.

1. An internal combustion engine for a motor vehicle, the internal combustion engine comprising:
a cylinder;
a cylinder head arranged to cover the cylinder;
a piston slidingly coupled to the cylinder inside the cylinder between a lower dead centre and an upper dead centre respectively further and closer than the cylinder head;
a first chamber defined between the cylinder, the cylinder head, and the piston;
a second chamber distinct from the first chamber and communicating with the first chamber via one or more ports formed on at least one component between the cylinder head and the cylinder;
fuel inlet means configured to introduce a fuel mixture into at least one between the first and second chambers;
an ignition device arranged at the second chamber and configured to ignite the fuel mixture in the second chamber; and
a vent line configured to vent gas from the second chamber, the vent line having an inlet end arranged at the second chamber.

2. The internal combustion engine according to claim 1, wherein the vent line is configured to recirculate vented gases from the second chamber into the first chamber.

3. The internal combustion engine according to claim 1, wherein the vent line comprises a valve device configured to control a flow of gas from the second chamber through the inlet end.

4. The internal combustion engine according to claim 3, further comprising a control unit configured to control the valve device and the ignition device as a function of a parameter indicative of a position or movement of the piston.

5. The internal combustion engine according to claim 4, wherein the control unit is configured to operate the ignition device to ignite the fuel mixture when the parameter indicates that the piston is at an ignition point, the control unit being also configured to operate the valve device to admit the flow of gas through the valve device from when the parameter indicates that the piston has passed an opening point during a movement of the piston toward the ignition point until the parameter indicates that the piston is at a further point before having reached the ignition point or coinciding with the ignition point.

6. The internal combustion engine according to claim 5, wherein said movement of the piston is also toward top dead centre.

7. The internal combustion engine according to claim 5, wherein the control unit is configured to operate the valve device so as to shut off the flow of gas through the valve device, thereby completely obstructing the inlet end, when the parameter indicates that the piston is arranged between the bottom dead centre and the opening point.

8. The internal combustion engine according to claim 5, wherein the control unit is configured to operate the valve device so as to shut off the flow of gas through the valve device, thereby completely obstructing the inlet end, when the parameter indicates that the piston is at the ignition point or that the piston has passed said further point.

9. A motor vehicle comprising an internal combustion engine according to claim 1.

10. An internal combustion engine for a motor vehicle, the internal combustion engine comprising:
a cylinder;
a cylinder head covering the cylinder;
a piston slideable inside the cylinder between a lower dead centre and an upper dead centre, the upper dead centre being closer to the cylinder head than the lower dead centre;
a first chamber defined between the cylinder, the cylinder head, and the piston;
a second chamber distinct from the first chamber and communicating with the first chamber via one or more ports formed on at least one of the cylinder head and the cylinder;
a fuel inlet configured to introduce a fuel mixture into at least one of the first chamber and the second chamber;
an ignition device arranged at the second chamber and configured to ignite the fuel mixture in the second chamber; and
a vent line configured to vent gas from the second chamber, the vent line having an inlet end arranged at the second chamber.
